(19) United States
(12) Patent Application Publication
(10) Pub. No.: US 2005/0081642 A1
(43) Pub. Date: Apr. 21, 2005

(54) Flow meter and flow metering system

(75) Inventors: James M. Nehl, Eden Prairie, MN (US); Neil R. Gansebom, Peshtigo, WI (US)

Correspondence Address: GRAY, PLANT, MOOTY, MOOTY & BENNETT, P.A., P.O. BOX 2906, MINNEAPOLIS, MN, 55402-0906, US

(73) Assignee: Water Monitor, Inc.

(21) Appl. No.: 10/964,029

(22) Filed: Oct. 12, 2004

Related U.S. Application Data
(60) Provisional application No. 60/512,642, filed on Oct. 15, 2003.

(51) Int. Cl. G01F 15/00

(52) U.S. Cl. 73/861.79

(57) ABSTRACT

A flow meter and a flow monitoring system using a plurality of such flow meters. The flow meter includes a tubular turbine housing having an axial flow passage containing a turbine. The turbine includes a turbine body and a plurality of turbine blades centrally connected to a turbine hub, which rotate the turbine upon fluid flow through the turbine housing. The rotation of the turbine is proportionate to the amount of fluid flowing through the turbine housing. A magnet is connected to the turbine for rotation with the turbine about a circular path of rotation. A reed switch housing is connected to the turbine housing. The reed switch housing includes a pair of parallel gusset plates connected to the turbine housing oriented in perpendicular relationship to the intended direction of fluid flow through the turbine housing, and end walls connected to the gusset plates to form a closed reed switch compartment. A reed switch assembly is contained in the reed switch housing. The reed switch housing is configured to hold the reed switch of the reed switch housing close by the path of travel of the magnet on the turbine so that the magnet closes the reed switch each time it passes, generating a pulse that is sent to a meter interface card and that represents passage of a certain quantity of fluid through the flow meter. A potting fills the reed switch compartment to hold the reed switch in place and protect the reed switch assembly.

### CROSS REFERENCE TO RELATED APPLICATION

This application claims the benefit of U.S. Provisional Application Ser. No. 60/512,642 filed Oct. 15, 2003.

### BACKGROUND OF THE INVENTION

Typically water consumption to individual units of a multiple living unit complex is not metered. The usual plumbing scheme of the complex makes such a task difficult. Commonly a single unit of the complex receives water through multiple supply lines which supply other units as well. For example, a single supply line can supply cold water to the kitchen sinks of multiple units while another supply line might supply water to the showers in the bathrooms of those units. For this reason it has been difficult to measure the water consumption of any individual unit for purposes of allocation of water consumption costs to the units. To address this problem, small meters have been developed which are installed in individual water lines in a unit. These meters generate and transmit signals indicative of water usage through the line, to a location which accumulates signals from a multiple of such meters installed in water supply lines to the unit for the purpose of measuring the total water consumption of the unit.

### SUMMARY OF THE INVENTION

The invention relates to a flow meter for monitoring the flow of a fluid, particularly water, to an individual water consuming fixture, and to a system for metering the collective water usage of a number of metered fixtures such as those in a single unit of an apartment in an apartment complex.

The flow meter comprises an inline turbine type flow meter for installation in an existing water line to be metered for purposes of cost allocation, leak detection or the like. The flow meter includes an inline turbine housing for connection in an existing or new water line. The turbine housing is tubular and has a cylindrical flow passage. A turbine assembly is installed in the flow passage. An upstream radial vane structure spans the flow passage and provides an upstream bearing seat for the turbine assembly. A downstream vane structure is provided by a retainer installed in the turbine housing downstream of the turbine assembly. The retainer provides a downstream bearing seat for the turbine assembly. The turbine assembly includes a tubular body with a cylindrical sidewall mounted for rotation about an axis parallel to the direction of fluid flow in the flow passage of the turbine housing. Turbine blades span the interior of the body. A central turbine shaft connects the turbine blades. The downstream end of the turbine shaft is seated in the downstream bearing seat. The upstream end of the turbine shaft is seated in the upstream bearing seat.

The turbine carries a magnet that travels a circular path of rotation as the turbine spins. A reed switch housing is attached to the turbine housing for containing a reed switch assembly. A reed switch is confined in the reed switch housing at a location close to the path of rotation of the magnet as it spins with the turbine assembly. The reed switch compartment is filled with a potting compound to secure and protect the reed switch assembly. The reed switch closes and generates a meter pulse each time the magnet passes the reed switch as the turbine spins.

The reed switch is connected to a meter interface card. A number of like flow meters can also be connected to the meter interface card. For example, a number of flow meters can be installed in a bathroom, one in a water supply line to the toilet, one in a water supply line leading to the bathtub/shower, and another leading to the sink. Hot and cold water usage at the shower and sink can be metered individually. The various meters can be connected to a common meter interface card. The meter interface card counts or accumulates the meter pulses received from the reed switches of the various meters. The meter interface card accumulates a number of meter pulses equaling a preselected total, such as a number corresponding to one gallon of water. Upon reaching such a level the meter interface card outputs a signal to a transmitter. The transmitter wirelessly communicates the signal to a receiver that is connected to a computer which can compile water consumption data separately from a number of meter interface cards. The data can subsequently be used for billing purposes.

### BRIEF DESCRIPTION OF THE DRAWINGS

FIG. 1 schematically depicts a flow meter installed in a water line and connected to a metering system;

FIG. 2 is a perspective view of the flow meter of FIG. 1 with a section of the flow turbine housing removed for purposes of illustration;

FIG. 3 is another perspective view of the flow meter of FIG. 2 viewed from the opposite end of that of FIG. 2;

FIG. 4 is an enlarged sectional view of the flow meter of FIGS. 2 and 3;

FIG. 5 is an assembly view of the flow meter of FIGS. 2 and 3;

FIG. 6 is a perspective view of the retainer of the flow meter of FIGS. 2 and 3;

FIG. 7 is a sectional view of the retainer of FIG. 6 taken along the line 7-7 thereof;

FIG. 8 is a perspective view of the turbine assembly of the flow meter of the invention;

FIG. 9 is a front view of the turbine assembly of FIG. 8; and

FIG. 10 is a sectional view of the turbine assembly of FIG. 9 taken along the line 10-10 thereof.

### DESCRIPTION OF THE PREFERRED EMBODIMENT

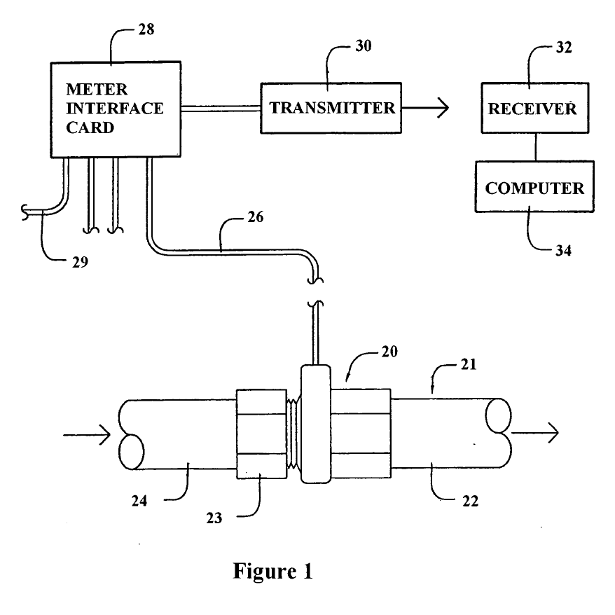

Referring to the drawings, there is shown in FIG. 1 a flow meter 20 installed intermediately in a water line 21 that has an upstream section 24 and a downstream section 22. Water line 21 can be a water supply line to a household plumbing fixture such as a sink or a toilet. Flow meter 20 meters the water consumption of the individual plumbing component. Flow meter 20 generates meter pulses indicative of the quantity of water passing through water line 21. Flow meter 20 is connected by lead 26 to a meter interface module or card 28. A plurality of other such flow meters can be connected to the meter interface card as well by means of electrical leads 29.

The meter interface card 28 counts or accumulates pulses from the various flow meters such as the flow meter 20. A predetermined number of flow meter pulses is representative of a larger known or determinable quantity of water such as a gallon. Meter interface card accumulates a number of flow meter pulses until the accumulated total reaches the predetermined number whereupon the meter interface card sends a signal to a transmitter 30. The signal represents a quantity of water that has passed through the various flow meters collectively. Once a signal is sent the internal counting register of the meter interface card resets to zero. The transmitter 30 wirelessly transmits to a computer 34 through a remote receiver 32. Receiver 32 identifies the signal as having come from a particular transmitter 30 and records it accordingly with the use of computer 34. The signals received from the interface cards are accumulated and translated into billing data. This enables, for example, the metering of water usage in individual apartments in an apartment complex.

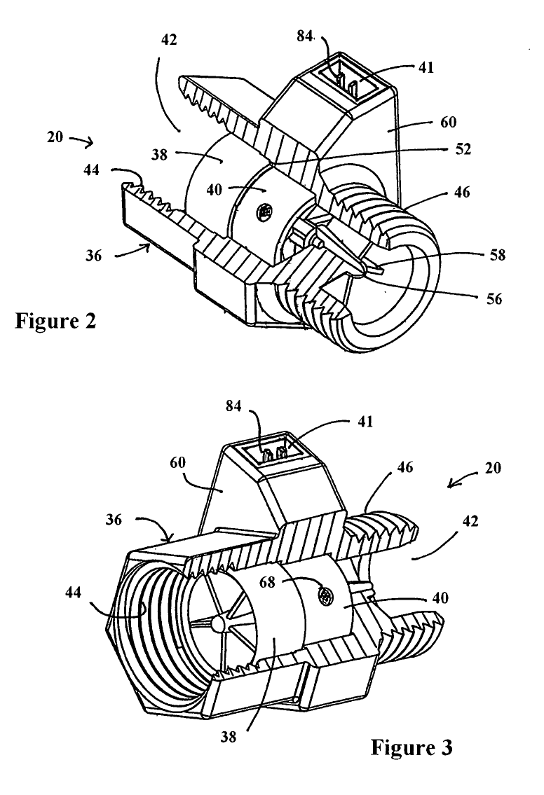

As shown in assembled relationship in FIGS. 2 and 3, flow meter 20 includes a turbine housing 36, a retainer 38, a turbine assembly 40 and a reed switch assembly 41. Turbine housing 36 is tubular and has a central flow passage 42. The outlet end of turbine housing 36 has interior threads 44 for connection to a downstream supply line section. The inlet end of turbine housing 36 has exterior threads 46 for connection to a corresponding upstream supply line section. Various types of fittings or connectors can be used.

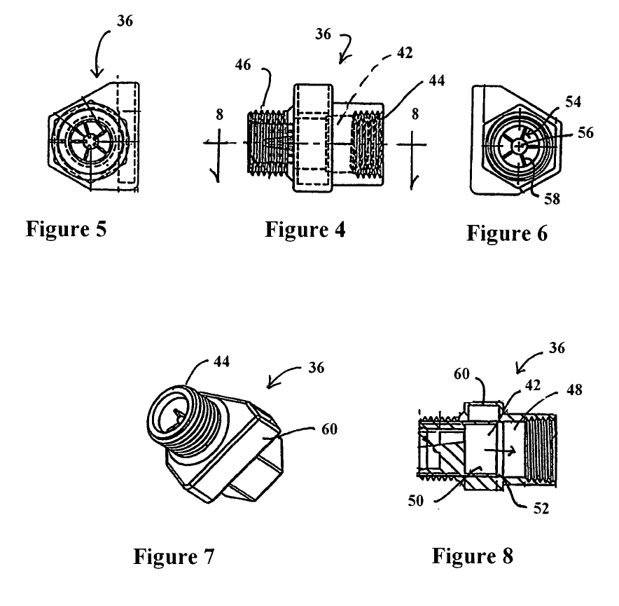

Turbine assembly 40 is centrally located in a turbine chamber 50 of central flow passage 42. Retainer 38 is located downstream of the turbine assembly 40. Central passage 42 has a downstream section 48 for holding the retainer (FIG. 4). Turbine chamber 50 is upstream of section 48 and separated from it by a shoulder 52. A web structure 54 is fixed to turbine housing 36 upstream of the turbine chamber 50. Web structure 54 includes radially extended upstream vanes 58 connected between turbine housing 36 and a central hub 56. Vanes 58 are slender and parallel to the direction of fluid flow to minimally impede fluid flow. Hub 56 provides an upstream bearing seat or pocket to the turbine assembly 40.

A reed switch housing 60 is attached to turbine housing 36. The purpose of reed switch housing 60 is to contain reed switch assembly 41 as will be described.

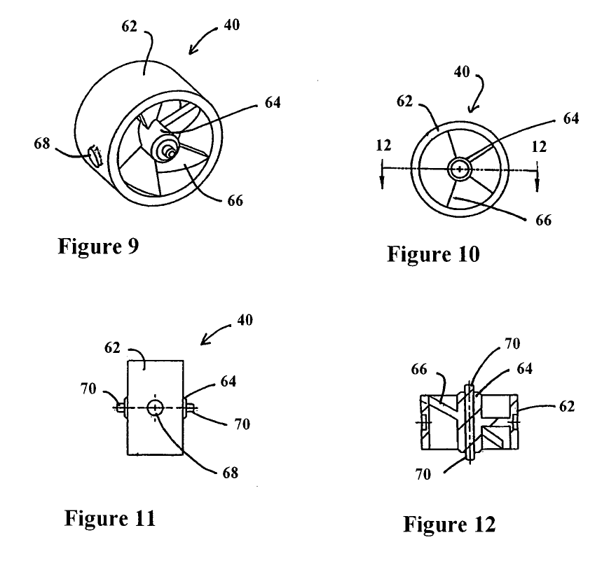

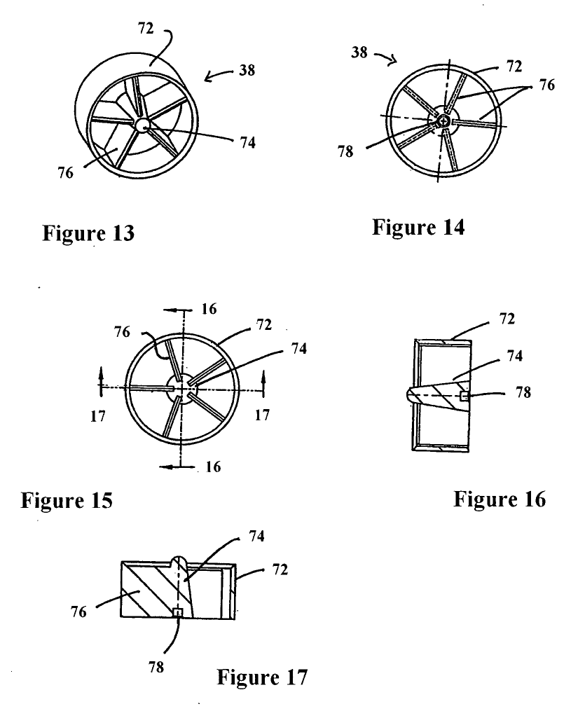

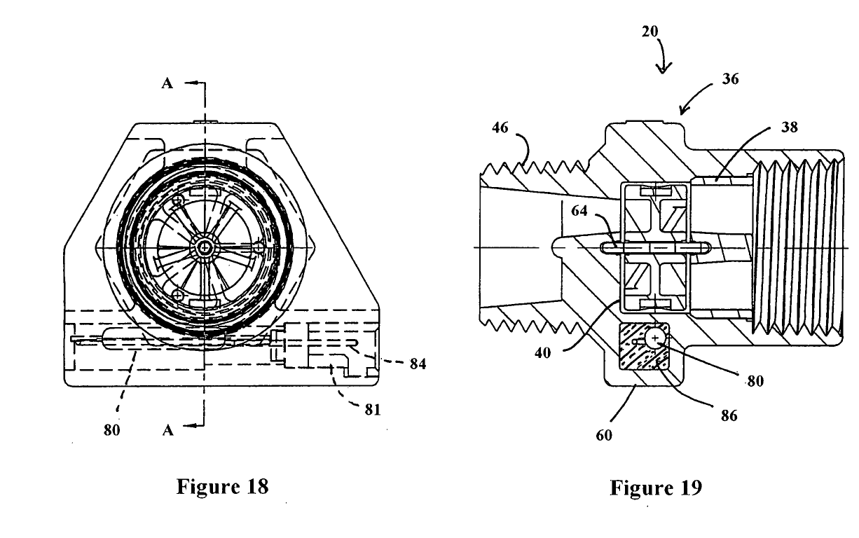

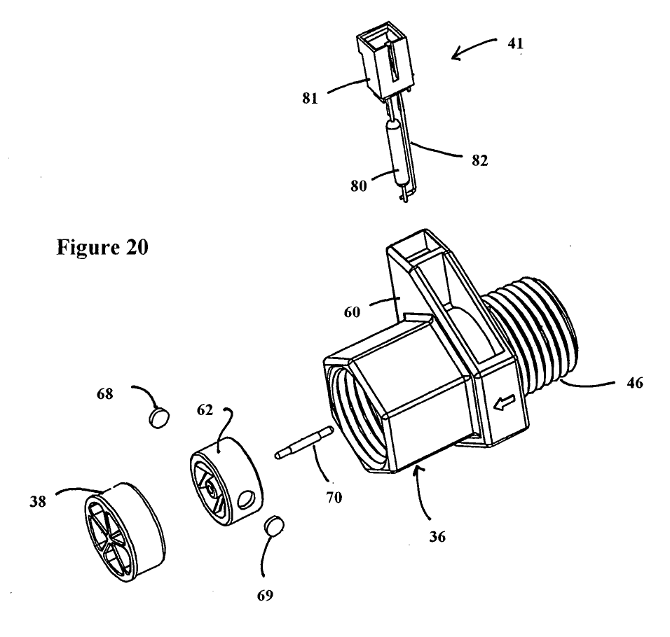

The turbine assembly is shown in FIGS. 8 through 10. Turbine assembly 40 includes a body 61 with a cylindrical wall 62. The outer surface of cylindrical wall 62 closely conforms to and is slightly spaced from the walls defining the turbine chamber 50. A hub 64 is connected to the wall 62 by turbine blades 66. Turbine blades 66 are flat and canted at an angle of attack to rotate of the turbine upon fluid flow. The turbine rotates an amount proportionate to the amount of fluid flow. A magnet 68 is installed in the sidewall 62. Magnet 68 can be pressed into the sidewall 62 so as to be flush with it. A counterweight 69 can be installed in sidewall 62 diametrically opposite to magnet 68. A turbine shaft 70 extends outward from either end of the hub 64. Ends of shaft 70 sit in upstream and downstream bearing seats for rotation of the turbine assembly 40 responsive to fluid flow.

Retainer 38 is shown in FIGS. 6 through 7. Retainer 38 has a cylindrical sidewall 72 that closely fits in the first section 48 of the turbine housing 36 and is intercepted by the shoulder 52. Retainer 38 has a central hub 74 supported centrally in the sidewall 72 by downstream radial vanes 76. Vanes 76 are flat and parallel to the direction of fluid flow. The upstream end of the hub 74 has a central bearing pocket 78. Bearing pocket 78 provides a downstream bearing seat for the turbine shaft 70.

In the assembled relationship of FIGS. 2 through 5 the turbine assembly 40 is in the turbine chamber 50 for rotation about an axis parallel to the direction of flow. The turbine 40 substantially fills passage 42. The upstream end of shaft 70 is seated in the upstream seat of hub 56 of web 54. The downstream end of shaft 70 is seated in the bearing pocket 78 of the hub 74 of the retainer 38. Retainer 38 can be secured to the turbine housing by suitable means such as ultrasonic welding.

Reed switch housing 60 includes a pair of parallel, spaced apart gussets or side walls 63 attached to the turbine housing perpendicular to the direction of fluid flow. A front wall 65 and a back wall 67 are connected to side walls 63 to form an enclosed compartment for containment of reed switch assembly 41.

Reed switch assembly 41 is located in the reed switch housing 60 in the vicinity of the turbine assembly 40. Reed switch assembly 41 includes a reed switch 80 that is closely spaced from the turbine 40 and separated from it by a wall of the turbine housing 36. As shown in FIG. 4 reed switch 80 is close enough to the turbine to sense passage of magnet 68 on its rotational path with the turbine sidewall 62 responsive to fluid flow.

FIG. 5 shows the parts of the meter 20 is assembly view relationship. The reed switch assembly 41 includes the reed switch 80 and a terminal box 81. Lead wires 82 connect the reed switch to terminals 84 shown in FIGS. 2 and 3. The terminals 84 are accessible for connection to a plug or to wires that connect the flow meter to the meter interface card 28. The reed switch assembly 41 fits in the reed switch housing 60 attached to turbine housing 36. Reed switch 80 is held in place by suitable potting 86 (FIG. 4). A reed switch typically is delicate and easily damaged. The potting 86 not only holds the reed switch 80 in place but protects it as well. Potting 86 can be epoxy potting or other preferred potting material.

In use the flow meter is installed in an existing water line 21 between upstream and downstream sections 22, 24. Turbine assembly 40 spins in turbine housing 36 responsive to the flow of fluid through the passage 42. The rotation of the turbine assembly 40 is proportionate to the volumetric flow of fluid through the water line. Magnet 68 closes the reed switch 80 each time it passes. The reed switch upon closing generates a meter pulse. The meter pulse is transmitted to the meter interface card 28. The meter interface card accumulates pulses that it receives from the various flow meters connected to it. Upon accumulation of a predetermined number of pulses, the meter interface card transmits a signal to the transmitter 30. The signal represents a quantity of water. The transmitter transmits the signal to a remote receiver 32 which distinguishes the meter interface card and transfers the information to the computer 34 in order to record water consumption by the collective meters connected to a particular meter interface card.

The various components of the flow meter are preferably formed of a hard, low friction, material such as a hard plastic. This will result in a low friction contact between the cylindrical sidewall 62 of the turbine assembly 40 and the corresponding interior sidewall of the flow passage 42. An example of such a plastic is that sold under the trademark Noryl.

1. A fluid flow meter for generating an electrical pulse indicative of fluid flow through a pipe, comprising:
a turbine housing having a central axial flow passage for fluid flow, an inlet end for connection to an upstream end of a fluid flow pipe, and an outlet end for connection to a downstream end of a fluid flow pipe;
said axial passage having a turbine chamber for accommodation of a turbine;
a turbine having a turbine body with a cylindrical sidewall installed in the turbine chamber, a turbine hub centrally aligned in the flow passage, and a plurality of turbine blades connected at inner ends to the turbine hub and at outer ends to the cylindrical sidewall, said blades canted at an angle of attack to the intended direction of fluid flow to cause rotation of the turbine responsive to fluid flow and proportionate to the amount of fluid flow;
a magnet installed on the turbine for rotation with the turbine about a circular path of travel as the turbine spins;
a reed switch assembly including a reed switch;
a reed switch housing connected to the turbine housing having a reed switch compartment for containing a reed switch assembly with a reed switch located in the compartment close by the path of travel of the magnet and spaced from it by a housing wall;
said reed switch assembly installed in the reed switch housing so that the reed switch closes each time the magnet passes by on its circular path of travel with the turbine in order to count revolutions of the turbine as indicative of a quantity of passing fluid; and
a potting filling the reed switch compartment.

2. The fluid flow meter of claim 1 including:
an upstream vane structure installed in the meter housing upstream of the turbine chamber, and a downstream vane structure installed in the meter housing downstream of the turbine chamber.

3. The fluid flow meter of claim 2 wherein:
said turbine assembly includes a turbine shaft attached to the turbine hub and having upstream and downstream ends;
said upstream vane structure having an upstream bearing seat for the upstream end of the turbine shaft, and said downstream vane structure having a downstream bearing seat for the turbine shaft.

4. The fluid flow meter of claim 3 wherein:
said downstream vane structure includes a retainer having a cylindrical sidewall closely fitting in the fluid flow passage of the turbine housing, a central hub, and a plurality of vanes connected between the hub and the retainer sidewall;
said hub having said downstream bearing seat for the turbine shaft.

5. The fluid flow meter of claim 4 wherein:
the retainer sidewall is fixed to the turbine housing.

6. The fluid flow meter of claim 1 wherein:
said turbine housing is generally cylindrical and has threaded inlet and outlet ends for connection in a fluid supply pipe;
said reed switch housing including a pair of parallel gusset plates connected to the meter housing perpendicular to the intended direction of fluid flow, and end walls connected to the gusset plates to form said compartment.

7. The flow meter of claim 6 including:
a meter interface card connected to the reed switch to accumulate pulses generated by the reed switch.

8. The fluid flow meter of claim 7 including:
an upstream vane structure installed in the meter housing upstream of the turbine chamber, and a downstream vane structure installed in the meter housing downstream of the turbine chamber.

9. The fluid flow meter of claim 8 wherein:
said turbine assembly includes a turbine shaft attached to the turbine hub and having upstream and downstream ends;
said upstream vane structure having an upstream bearing seat for the upstream end of the turbine shaft, and said downstream vane structure having a downstream bearing seat for the turbine shaft.

10. A flow monitoring system for monitoring flow in a fluid flow pipe, comprising:
a plurality of flow meters, each flow meter having a turbine housing having a central axial flow passage for fluid flow, an inlet end for connection to an upstream end of a fluid flow pipe, and an outlet end for connection to a downstream end of a fluid flow pipe;
said axial passage of the turbine housing of the flow meter having a turbine chamber for accommodation of a turbine;
a turbine having a turbine body with a cylindrical sidewall installed in the turbine chamber of the turbine housing, a turbine hub centrally aligned in the flow passage, and a plurality of turbine blades connected at inner ends to the turbine hub and at outer ends to the cylindrical sidewall, said blades canted at an angle of attack to the direction of fluid flow to cause rotation of the turbine responsive to fluid flow and proportionate to the amount of fluid flow;
a magnet installed on the turbine for rotation with the turbine about a circular path of travel as the turbine spins;
a reed switch assembly including a reed switch;
a reed switch housing connected to the turbine housing having a reed switch compartment for containing a reed switch assembly with a reed switch located in the compartment close by the path of travel of the magnet and spaced from it by a housing wall;
said reed switch assembly installed in the reed switch housing so that the reed switch closes each time the magnet passes by on its circular path of travel with the turbine in order to count revolutions of the turbine as indicative of a quantity of passing fluid;
a potting filling the reed switch compartment;
a meter interface card connected to the reed switch of each of the flow meters to accumulate pulses generated by the reed switches of the flow meters and configured to generate a signal when a predetermined number of pulses from the reed switches have been accumulated;
a transmitter connected to the meter interface card for receipt of signals from the meter interface indicative of a quantity of fluid passing through the flow meters and retransmitting the signal wirelessly to a remote receiver for collection and processing of the signals.

11. The flow monitoring system of claim 10 including:
an upstream vane structure installed in the meter housing upstream of the turbine chamber, and a downstream vane structure installed in the meter housing downstream of the turbine chamber.

12. The flow monitoring system of claim 11 wherein:
said turbine assembly includes a turbine shaft attached to the turbine hub and having upstream and downstream ends;
said upstream vane structure having an upstream bearing seat for the upstream end of the turbine shaft, and said downstream vane structure having a downstream bearing seat for the turbine shaft.

13. The flow monitoring system of claim 12 wherein:
said downstream vane structure includes a retainer having a cylindrical sidewall closely fitting in the fluid flow passage of the turbine housing, a central hub, and a plurality of vanes connected between the hub and the retainer sidewall;
said hub having said downstream bearing seat for the turbine shaft.

14. The flow monitoring system of claim 13 wherein:
the retainer sidewall is fixed to the turbine housing.

15. The flow monitoring system of claim 11 wherein:
said turbine housing is generally cylindrical and has threaded inlet and outlet ends for connection in a fluid supply pipe;
said reed switch housing including a pair of parallel gusset plates connected to the meter housing perpendicular to the intended direction of fluid flow, and end walls connected to the gusset plates to form said compartment.

16. The flow monitoring system of claim 15 including:
an upstream vane structure installed in the meter housing upstream of the turbine chamber, and a downstream vane structure installed in the meter housing downstream of the meter housing.

17. The flow monitoring system of claim 16 wherein:
said turbine assembly includes a turbine shaft attached to the turbine hub and having upstream and downstream ends;
said upstream vane structure having an upstream bearing seat for the upstream end of the turbine shaft, and said downstream vane structure having a downstream bearing seat for the turbine shaft.
